(19) United States
(12) Patent Application Publication
(10) Pub. No.: US 2009/0129197 A1
(43) Pub. Date: May 21, 2009

(54) METHOD AND DEVICE FOR INDUCTION STIRRING OF MOLTEN METAL

(75) Inventor: Eduard Isidorov, Riga (LV)

Correspondence Address: SUGHRUE MION, PLLC, 2100 PENNSYLVANIA AVENUE, N.W., SUITE 800, WASHINGTON, DC, 20037, US

(73) Assignee: SIA Gors, Riga (LV)

(21) Appl. No.: 12/297,535

(22) PCT Filed: Apr. 5, 2007
(86) PCT No.: PCT/LV2007/000001

§ 371 Date: Oct. 17, 2008

(30) Foreign Application Priority Data
Apr. 19, 2006 (LV) P 06 59

(51) Int. Cl. F27D 23/04; B01F 11/02

(52) U.S. Cl. 366/127; 266/234

(57) ABSTRACT

The invention relates to a method and device for the induction stirring of liquid metal in the bath of a reverberatory furnace by the action of a traveling magnetic field whose frequency ranges from 50 to 60 Hz. The inventive method consists in producing a magnetic field action on a molten metal at a height of (0.1-0.5)H from the furnace bottom, wherein H is the bath depth, and, in a horizontal direction, along the plane of a chamber (3) bottom which is located behind of the furnace wall. The inventive device in embodied in the form of a module which comprises a load-gripping unit for lifting and displacing a load, a flange and parts for fixing said module to the wall of the furnace bath. The module consists of a frame (12) provided with a unit (2), which is arranged therein and is made of a material resistant to the molten metal action, and with the inductor (1) of the traveling magnetic field. A chamber (3) is positioned along the longitudinal axis of the unit (2) and the inductor is horizontally placed under the chamber (3) bottom. The device is used for carrying out the jet stirring of the molten metal in the furnace bath, for melting a fragmented scrap in a transferred metal steam, for refining the molten metal by blowing a gas-flux mixture in the device chamber and for running the molten metal in a furnace-receiver of the molten metal or another container. Said invention makes it possible to reduce the furnace shutdown by 50% in comparison with a steady magnetic field and to substantially ease the working conditions.

### TECHNICAL FIELD

This inventions relates to metallurgy, more particularly this invention is concerned with methods and devices for stirring molten metal (alluminium, its alloys) in vessel of reverberatory furnaces.

In induction type furnaces the major part of the capacity of the magnetic field is used for heating, stirring of the molten metal is attendant process. This invention is concerned with provision of method and device, intended primarily for induction stirring of molten metal.

### PRIOR ART

There are known a method and an apparatus [U.S. Pat. No. 5,948,138 Sep. 7, 1999, Issidorov, “Method and apparatus for stirring of molten metal using electromagnetic field”, C22B 9/187] for stirring molten metal in the vessel of the furnace by using electromagnetic field. The inductor of the running magnetic field is positioned along vertical wall of the furnace. The furnace contains the passageway for molten metal. The incoming stream of molten metal from the passageway into the vessel is directed mainly along a wall of a vessel.

Intensity of the jet-mixing in the middle of the vessel is lower than along the walls there of, thus for melting of solid metal in the middle of the vessel additional mechanical-contact stirring is required.

Another shortcoming, limiting the using of said method and apparatus, is the necessity of long-term stoppage of the furnace for dismantling of the inductor and for replacement of plates for removal of slag from the passageway.

A furnace [U.S. Pat. No. 4,685,657 Aug. 11, 1987. Kunio Okubo, Ise et al. “Melting Furnace”, C22B 9/16] is known with a fixed pocket along end of the furnace, underneath which the inductor is placed. The bottom of the pocket is located flush with the bottom of the furnace.

Metal pumps along the pocket and comes in the vessel through window in the wall of the vessel. Intensity of the stirring in the middle of the vessel is lower than on the sides of the vessel.

Invention is known [U.S. Pat. No. 4,355,789 Oct. 26, 1982, Boris Dolzhenkov et al. “Gas pump for stirring molten metal”], aim of which is to provide apparatus for stirring, that does not require any substantial reconstruction of the melting furnace and which has to secure the effective jet-mixing of the molten metal in the vessel of the melting furnace. Stirring is achieved in the intermittent regime.

Set aim is not reached, because the mass of the molten metal, which may be discarded into the vessel of the furnace in the form of a jet, cannot exceed the capacity of the pipe of an apparatus.

Shortcomings of said apparatus are the laboriousness of the removal of slag from the pipe, the complexity of travel of the pipe of the mechanical drive pump.

Problem of providing an apparatus mounting which does not involve the substantial reconstruction of the furnace, is solved partially according to patent application [Peel et al, “Furnaces and methods of melting”, US Patent Application Publication, Pub Nr. US 2005/0035503 A1, Feb. 17, 2005 Int. CL. C21C 5/42].

The stirrer is made in the form of a module, which contains electromagnetic pump and crucible, that are joined with a furnace by pipes. Shortcomings of said apparatus are the necessity for permanent circulation in order to avoid the freeze of the molten metal in pipes and the laboriousness of the dismantling of the whole apparatus for removal of slag.

Substantial shortcomings include the fact, that the surface of the molten metal in the funnel, that is made in the course of rotation of the molten metal in the crucible oxidizes and the oxide film draws in the volume of the molten metal that is pumped over.

As a prototype where aims of an invention achieved are more like is chosen a patent application [Houghton, “Apparatus for stirring molten metal comprising electromagnetic induction”, UK Patent application GB 2 3 89 645 A, 17 Dec. 2003].

A structure of an apparatus comprises running magnetic field inductor and a channel in the form of a chute in unit. A unit is build in the wall of a vessel of the furnace. Molten metal circulates under the influence of the running magnetic field of an inductor, which is mounted under the sloping bottom of the chute. Scrap (crushed metal, metal chips) is fed into the chute on the surface of the molten metal that is pumped over and these materials are kneaded into the molten metal. After the reverse of the direction of running magnetic field spreading the molten metal rises by the slopped chute and overflows from the furnace into another reservoir.

Shortcomings:
having the level of the molten metal below the upper end of the inductor the magnetic field along the upper part of the inductor is not being used for stirring of molten metal;
intensive stirring, oxidizing and kneading of oxides at overflow of the molten metal;
laboriousness, hard work conditions and the necessity for long term stoppage of the furnace while replacing plates at the bottom of the chute over the inductor.

### ESSENCE OF THE INVENTION

Invention is aimed at providing a method and apparatus for more effective if compared with analogues stirring of the molten metal in the vessel of reverberatory type furnace under the influence of the running magnetic field of the industrial (low) frequency (50:60 Hz), wherein the mounting of an apparatus does not require the substantial reconstruction of the furnace and the repair there of requires stoppage of a furnace for a minimal duration. Apparatus is intended for using as in the structure of furnaces for melting of the solid metal, as in the mixture-furnaces with molten metal for refinement of the molten metal and for preparation of alloys.

Modifications of apparatus might be used for kneading and melting in the jet of the pumped molten metal of different types of the crushed scrap, as well as for the overflow of the molten metal from the furnace.

The aim is reached by means of creation of such nature of the stirring, wherein the molten metal from the upper layer in the vessel of the furnace, being heated by the flame of burners, submerges in the effective area of the running magnetic field and travels in the form of a flat drowned jet along the bottom of the vessel of the furnace at a speed, necessary for the washing out of the charging of the solid metal on the bottom of the vessel.

In contrast to the known methods the molten metal is influenced by running magnetic field along horizontal plane—the bottom of the chamber at a heigh over the bottom of the vessel from 0.1 H to 0.5 H, where H—is a depth of the vessel of the furnace.

Method is implemented with the use of an apparatus, which is realized in the form of a separate module, which contains in its structure an inductor of the running magnetic field and a unit, wherein the channel in the form of a chamber is located, having been limited all length of the end wall of the unit, the inductor is located horizontally under the chamber, the module is furnished with means for its travel and mounting on the wall of the vessel of the furnace. The module is assembled for mounting on the furnace.

In the wall of the vessel is mounted a unit-adaptor with a window, having from the outside wall a form and dimensions of a chamber of the attached unit. The width of the window in the unit-adaptor increases to the side of the vessel.

The chamber which bottom is located higher than the bottom of the vessel is filled up with molten metal after the temperature of the molten metal exceeds the melting temperature of the solid metal. Efficacy of the stirring at that is higher than at the early stage of the melting, when the level of the molten metal is lower than 0.1 H of the depth of the vessel, and temperature of the molten metal is equal to that of the crystallization.

Maximum height—0.5 H, is limited by that with augmentation of the height of the bottom of the chamber over the bottom of the vessel the height of the column of the molten metal over the bottom of the chamber decreases, which determines the metal static pressure under the influence of which the molten metal flows from the vessel into the chamber. That leads to the reduction of the entry of the molten metal from the vessel into the chamber, increase of the loss of electromagnetic capacity for stirring of the molten metal directly in the chamber and as a consequence—to the reduction of the speed of entry of the jet into the vessel of the furnace.

Pressure of the molten metal on the bottom of the furnace, located over the bottom of the vessel, is lower by Δ h=(0.1-0.5)H and the peril of leakage of the molten metal through the plates, separating the inductor is lower than in the known apparatus of analogical purpose.

Jet-mixing is realized in the intermittent regime. The speed of jet inflow into the vessel over the range from 0.5 to 5.0 m/per second and the mass of the pumped molten metal during one period—from 0.3 to 3.0 G—of the mass of the molten metal in the vessel of the furnace, is set up depending on the stage of the manufacturing method.

The refinement of the molten metal in the vessel of the furnace is realized by purge of the pumped metal by the gas-flux mixture in the chamber of the apparatus. The mixture is purged in the zone where the molten metal changes its stir direction and submerges to the bottom of the chamber.

For melting of the crushed scrap, chips in the jet of the pumped molten metal, the apparatus has a modification, which differs in that the end wall of the chamber is realized with a slope to the side of the wall of the furnace and over the chamber is placed a mechanism of said material feed.

Nature of the movement of the molten metal along and all length the chamber, wherein the substratum of the metal stirs to the opposite to the upper layer direction, enables to realize the method of melting of the solid metal in the chamber, characterized in that the jet of the molten metal, which stirs along the surface, washes out the lower part of the crushed solid metal fed into the chamber likewise melting of ingots, coarse scrap in the vessel of the furnace. The melting continues at the submerging of the jet with captured pieces of scrap, further its travel along the bottom of the chamber and afterwards—in the vessel of the furnace. The solid material submerges into the molten metal in the chamber under the influence of its own weight (crushed solid scrap iron), but chips and other types of light crushed scrap are melted with the use of mechanical devices, such as for example auger.

Having such method of melting the loss of metal and soiling thereof with oxides are reduced.

Modification of an apparatus which is intended for realizing of an additional function—overflow of the molten metal, is characterized in that in the end of the wall of the chamber there is a channel adjoining in the lower part to the bottom of the chamber, and in the upper part to the chute for overflow of the molten metal from the vessel of the furnace into other reservoir. The molten metal under the influence of the running magnetic field, expanding along the bottom to the side of the end wall of the chamber gathers speed along the bottom of the chamber, ascends the channel and further overflows by the chute into the reservoir outside the vessel of the furnace. In the modification of an apparatus for induction-siphon overflow dynamic head of the jet provides for the raise of the molten metal by the channel to the height sufficient for displacement of an air from the pipe-siphon over the chamber, and the overflow of the molten metal from the vessel takes place under the influence of the magnetic field and as a result of the use of the siphon effect.

The overflow method described enables to realize crushed scrap melting method characterized in that after the overflow of the part of the molten metal the subsequent scrap melting is made in the molten metal remaining in the vessel, the level thereof being minimum before the beginning of the scrap feed and highest possible—at the end of the feed, is maintained over the optimal range.

### CONSTRUCTION. BRIEF DESCRIPTION OF DRAWINGS

The invention will be further described based on an example with reference to drawings attached.

FIG. 1. Module in the assembled form.

FIG. 2. General view of the module on the wall of the round furnace.

FIG. 3. General view of the module on the wall of the rectangular furnace.

FIG. 4. The module (the modification with the refinement chamber), longitudinal slit.

FIG. 5. The module (the modification for the kneading of chips, overflow of the molten metal).

FIG. 6. The module (the modification for the kneading of chips, overflow of the molten metal), longitudinal slit.

FIG. 7. The module on the wall of the round furnace, longitudinal slit.

FIG. 8. The module on the wall of the round furnace, horizontal slit.

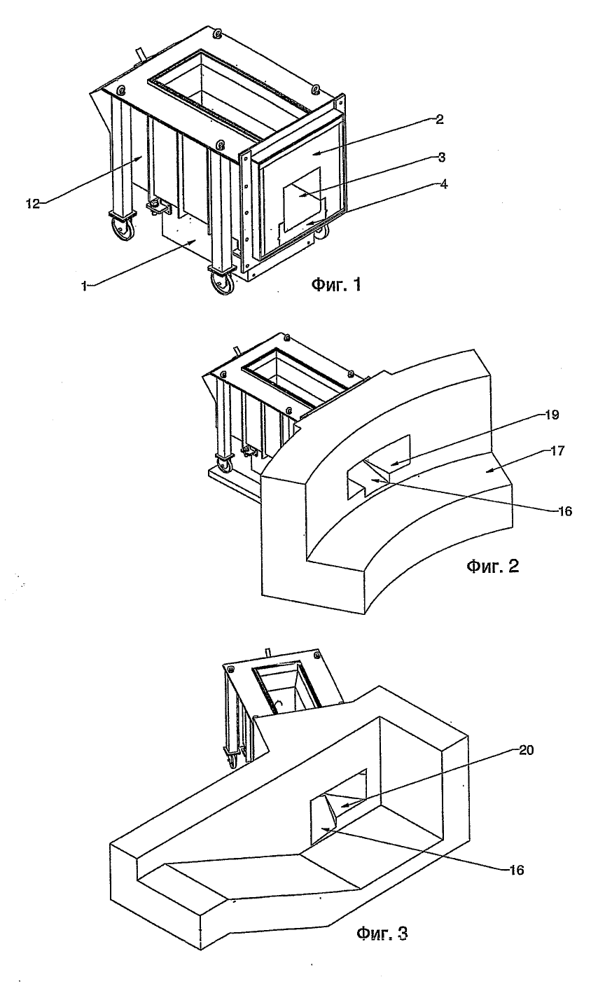

The module (FIGS. 1, 4, 5) comprises in its structure the inductor (1) of the running magnetic field and the rectangular unit (2) of a concrete, along which there is a chamber (3). The bottom of the chamber (3) between the longitudinal walls of the unit is overlapped with plates (4), over the chamber (3) the lid (5) is mounted. In the end of the chamber (3) there is a sloping aperture (6), whereto the pipe (7) for the gas-flux mixture feed is attached. Inclination of the end wall to the bottom of the chamber is α=60-80°.

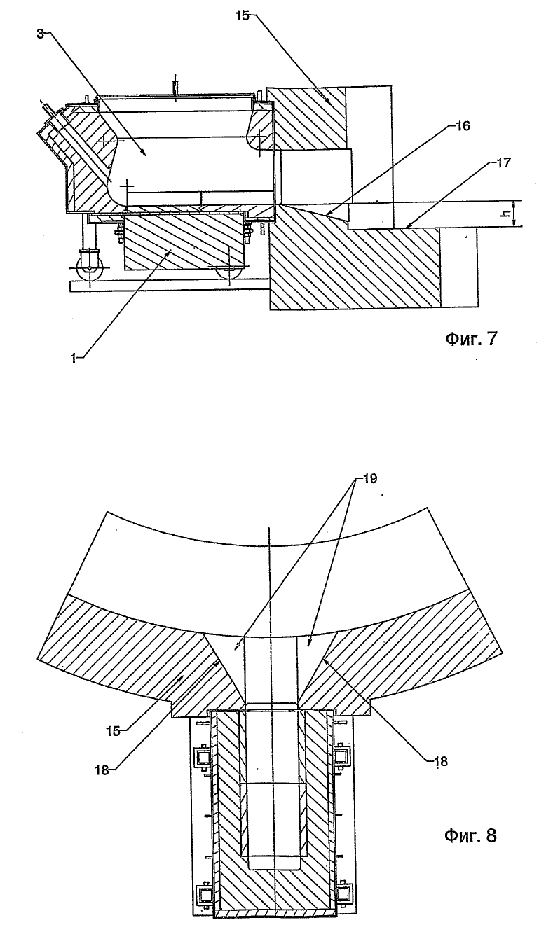

To the lid (8) (FIG. 6.) the system (9) of the crushed scrap, chips feed is adjoined. In the end of said chamber is a channel (10) made in the form of a flat trench, the height thereof being within the limits (1.0-2.0)d″ (d″—the depth of the penetration of the variable magnetic field into the molten metal). In the upper part of the chamber the chute (11) adjoins the channel.

Unit (2) with a chamber is located in the metallic frame (12).

The inductor (1) and the frame (12) are supplied with clamps (13) for the fixation of the inductor (1) on the frame (12). The frame has supports (14) with wheels and weight capturing facilities for the uplifting and travel of the module.

The module is mounted on the wall of the vessel of the furnace. The depth of the vessel—H. The longitudinal axis of the module (FIGS. 2, 8) goes through the center of the round furnace. In the wall of the vessel there is a unit-adaptor (15) with a window, dimensions and profile thereof from the outside of the wall are identical with the chamber (3) in the attached module. The bottom (16) of the window in the unit (15) has an inclination to the side of the bottom (17) of the vessel of the furnace edgewise the chamber (3). Side walls (18) of the window in the unit-adaptor (15) are located at an angle to the longitudinal axis and the window in the adaptor expands to the side of the vessel, bottom (19) of the window sections expanding in the unit along side walls (18) is located at the level of the bottom of the chamber (3).

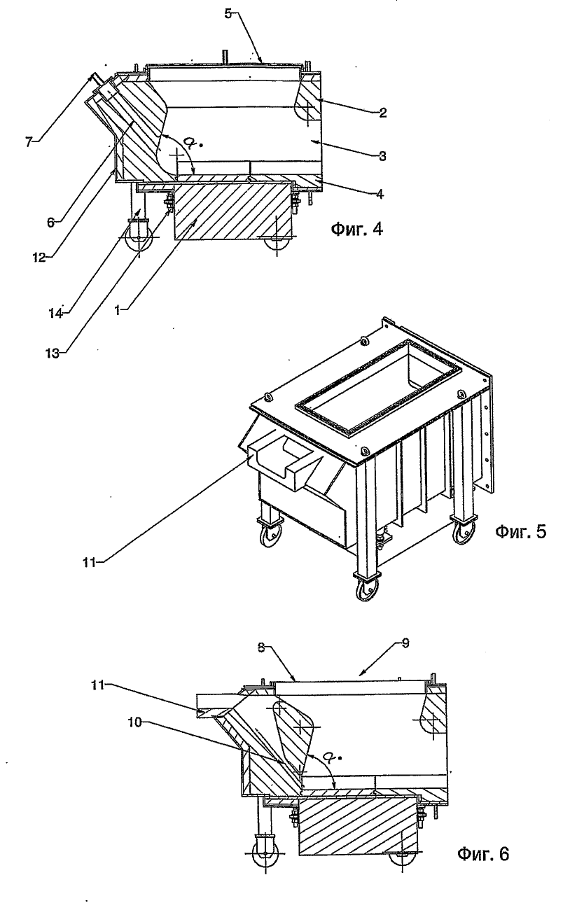

At mounting the module on the wall of the rectangular furnace (FIG. 3) the window in the unit expands from the side of the vessel to one of the sides and this section of the window (20) has in the view on the plan a form of a triangle.

### DESCRIPTION OF WORK

The module is assembled to be mounted on the furnace. The unit-adaptor is mounted in the aperture in the wall of the vessel of the furnace. On the surface of the unit-adaptor in the wall of the vessel gaskets from the resilient heat-resistant material are stuck and the module is pressed to the unit-adaptor.

Solid metal (ingots, scrap) is fed to the bottom of the vessel, afterwards is heated and melted under the influence of the flame of burners of the furnace. At the initial stage of melting the temperature of the molten metal flowing to the bottom of the vessel, is equal with the temperature of crystallization. The stirring at the level below 0.1 H and accordingly—under the low level of heat content in the molten metal is ineffective.

The chamber (3) of the module the bottom of which is located over the bottom of the vessel at h=(0.1-0.5)H, is filled at a later stage of melting. The stirring begins (first stage) after the raising of the level of the molten metal over the bottom of the chamber. The molten metal from the chamber (3) under the influence of the running magnetic field induced by the inductor (1), located under the bottom of the chamber, returns to the vessel of the furnace.

At this stage the temperature of the upper layer of the molten metal exceeds the temperature of the melting of the solid metal and the stirring gives a possibility to provide for the heating and the backwashing of the chamber by the incoming molten metal from the vessel. The stirring regime:—the speed of the jet at the entrance into the vessel and the duration of the stirring—minimum.

The molten metal from the upper layer in the vessel flows into the chamber (3) to take place of the pumped metal. At that the molten metal stirs all length the chamber (3) to opposite directions and with different speeds.

In the effective area of the running magnetic field, that spreads along the inductor at a speed 30-60 m/per second, the speed of the flat jet stir along the bottom of the chamber (3) is maximum and lowers rapidly as moving off the bottom of the chamber. The thickness (b) of the pumped layer—flat jet is determined by the depth (d) of the penetration of the variable magnetic field (50:60 Hz) into the molten metal and the ductility of the molten metal. The maximum thickness of the layer (b) is within the limits b=3 d. The gradient of stirring speeds along the height of the chamber (3) leads to the origination in the chamber (3) of the pressure gradient and as a result—to the vertical circulation of the molten metal. The metal from the upper layer, having higher temperature and consequently—being lighter than at the bottom is drawn into the low pressure zone at the bottom of the chamber (3) and returns to the vessel of the furnace in the form of the drowned jet. At stirring along the sloping bottom of the window in the unit-adaptor (15) the jet submerges owing to “the adhesion effect to the solid surface” and further spreads along the bottom of the vessel of the furnace.

In the furnace of round type, the jet of the molten metal goes through the center of the vessel with a maximum speed, which is provided by the apparatus, washes out the base of the charging of the solid metal on the bottom. At that in the vessel of the furnace two circular contours are formed being directed towards each other, the molten metal thereof is blended in the window in the unit-adaptor (15) and at stirring along the chamber of the apparatus. That part of the molten metal which flows into the chamber along the side walls (18) over the bottom (19) of sections of the window extending in the unit-adaptor (15), is blended.

In the furnace of the rectangular type of the vessel the module is mounted in such way, that its longitudinal axis goes at angle to the wall of the furnace and the jet is directed to the side of the section of the bottom of the vessel which raises to the doorway of the furnace. The molten metal flows from the vessel into the chamber mainly along the wall of the window section extending to the vessel in the unit-adaptor and the molten metal in the vessel under the influence of the jet, incoming from the chamber, is put in rotatory movement as in the furnace with a round vessel.

The speed of the inflow of the jet of the molten metal into the vessel is regulated by changing the voltage on the winding of the inductor. The adjustment range (0.5-1.1) Unom (rated voltage). At the voltage lower than 0.5 Unom the capacity transmitted into the molten metal does not exceed 25% of the rated and the adjustment of the voltage lower than said value is inexpedient. The upper boundary of the voltage is usually limited by performance attributes of the accessory equipement. The speed of the jet might be adjusted by way of changing the frequency of the alternating current and consequently—of the running magnetic field.

The stirring is made in the intermittent regime, alternating the stirring at duration 3-10 minutes, during which from 0.5 G to 3.0 G, where G, t—is the mass of the molten metal in the vessel of the furnace is pumped over, pauses at duration from 3 minutes and on. The stirring in the intermittent regime has advantages comparing to continuous stirring, because on the one hand the degree of turbulization of the molten metal in the vessel of the furnace increases, on the other hand—the duration of the engaging of the inductor decreases at the expense of pauses and consequently the expenditure of the electric power decreases and the heat regime of the work of the inductor facilitates.

Intensive at most stirring is made after the solid metal is fully melted, at the stage of heating of the molten metal up to the set temperature, and when treating of the molten metal by fluxes.

Minimum intensity (the speed of the jet not higher than 1.0 m/per second)—at the stage of the washing out at completion of the chamber with the molten metal flowing from the vessel.

The purification of the molten metal from the hydrogen and aluminium oxide is made by purge of the pumped molten metal with gas-flux mixture. The mixture is fed into the molten metal through the sloping aperture in the end of the unit under the pressure necessary for the displacement of the molten metal from the aperture. The gas-flux mixture bubbles through the motlen metal stirring towards. The inert gas with the remainders of a flux fills the volume of the chamber over the molten metal and secures the protection of the surface of the metal being intensively stirred with the floating gas bubbles from the oxidizing.

The stirring of the molten metal at the stage of refinement is made in the continuous regime (without pauses).

In the modification of the apparatus (FIGS. 5, 6) for the melting of the crushed scrap, chips, materials are fed into the chamber through the aperture in the lid (8) over the chamber (3). The crushed material is dragged to the bottom of the chamber by the jet of the molten metal, is transferred to the vessel of the furnace and is melted in the metal being stirred.

After the completion of the melting of the crushed material and raising of the level in the vessel up to the face value the molten metal melted at this stage is transferred from the melting furnace into another reservoir. For realization of this procedure the phase sequence of the winding of the inductor is changed—the direction of the spreading of the running magnetic field is reversed.

The molten metal under the influence of magnetic field, spreading to the side of the end wall of the chamber (3), gathers speed along the bottom of the chamber and ascends the channel (10). Dynamic pressure of the jet, stirring along the bottom of the chamber, ensures the rising of the metal by the channel to the height sufficient for the overflow of the molten metal from the furnace by the chute (11).

The overflow of the molten metal from the furnace might be made as under the influence of the magnetic field only, as in the result of an additional use of the gradient of potential energy from the level difference in between the metal overflow in the chamber and reservoir, whereto the overflow is directed. For realization of this method of overflow in the upper part of the channel attached thereto is the pipe-siphon, which is filled with the molten metal, displacing the air therefrom. The molten metal ascends the channel and begins to overflow by the pipe of the siphon under the influence of the magnetic field.

Further melting of the scrap after the overflow of the part of the molten metal is made in the molten metal remaining in the vessel. After the overflow of the molten metal from the furnace the purification of walls of the chamber from the slag is made. The periodicity of the purification is set by the processing regulations.

For the repair the module is withdrawn from the furnace. At that the cooling of the furnace if not required, as it is necessary for repair of an apparatus—prototype. Instead of the withdrawn, the backup module might be mounted on the furnace, at that the duration of the stoppage of the furnace is reduced to minimum.

The method of induction jet-mixing intended at increasing the efficacy of the metal melting in the vessel of the furnace is to be explaned with the following example.

The description of the method is provided for furnaces of the reverberatory type with round vessel, supplied with burners for heating and melting of the solid metal, being fed onto the bottom of the vessel. The holding capacity of the vessel—the mass of the molten metal 60 t. In the wall of the vessel there is an opening, where the unit-adaptor is located. The section of the bottom of the window in the unit-adaptor from the outside wall is located at the height 250 mm over the bottom of the vessel. The depth of the vessel—900 mm.

The module is mounted on the wall of the furnace and adjoins the window in the wall of the furnace. The bottom of the chamber in the module is located at the height of 250 mm relative to the bottom of the vessel of the furnace. The inductor is located under the bottom of the chamber. The legth of the chamber is 1300 mm. The materials for construction of units, plates—concrete CARATH 1400LC AL, REFRAX RC.

The module is fastened on the frame of the furnace by bolts, in between the end of the unit and unit-adaptor in the wall of the vessel there is a gasket made of resilient material (Duraboard, 10 mm).

Power supply: 400V, 50 Hz, 3 phases, capacity 65 kW.

The solid metal (ingots, scrap) is fed onto the bottom of the vessel, burners are switched on and the metal is being heated. The stirring of the molten metal begins after the melting of the part of the metal sufficient for raising the level of the molten metal up to the height of 300-350 mm over the bottom of the vessel of the furnace.

Stirring regime: voltage on the inductor is 280-320V, the duration of stirring/pauses—3/3 minutes. The duration of the cycle is set based on the duration of the raising of the level of the molten metal up to the height of 500-550 mm.

Further stirring regime:—voltage on the inductor is 100% (400 V, engine rated capacity, kW), the duration of stirring/pauses—5/5 minutes, the duration of a cycle—until the full melting of the solid metal. The speed of the flat jet at the entrance into the vessel is 3.0 m/per second. Bulk feed up to 12 t/per minute.

The duration of stirring/pauses at heating of the molten metal up to the set temperature 6/3 minutes.

The further procedure—elimination of the hydrogen and aluminium oxide, made by the purging of the pumped molten metal with gas-flux mixture. The mixture is fed into the molten metal through the sloping aperture in the end of the unit under the pressure 0.5-1.0 bar. The duration of the stirring of the molten metal in the continuous regime (without pauses) 20-30 minutes. The depth of the purification—40-50% of the initial content of admixtures.

In comparison with the stirring by the apparatus-prototype the speed of melting at using claimed method and apparatus is increased by 20%, the fuel depletion and metal loss are decreased by 15% and 25% accordingly.

The purification of walls of the chamber from slag is made with lid removed after the overflow of the molten metal from the furnace.

The dismantling of the module for changing of the plates is made with periodicity 12 months and more.

The method of induction jet-mixing in the furnace for melting of crushed solid scrap and other types of grinded scrap is explained based on the following example.

The module is mounted on the end wall of the vessel of the 30 t furnace of the rectangular form. The longitudinal axis of the module is directed at angle of 60° relative to the end of the furnace. The depth of the vessel is 750 mm. The bottom of the module is located at the height of 100 mm over the bottom of the furnace. The inductor is mounted under the bottom of the chamber, the length of the unductor is 900 mm, the length of the chamber 1300 mm.

To the vessel of the furnace 12-14 of the solid scrap is fed, sufficient to fill the vessel with the molten metal up to the height of 300-350 mm. The molten metal is heated up to the temperature 750-760°. The metal is melted and heated up to the set temperature, ensuring the stirring according to the method above described.

Crushed material begins to be fed into the chamber of the module at the level of the pumped molten metal over the bottom of the chamber being 200-250 mm. The speed of feed is up to 5 t/per hour. The molten metal is pumped over through the chamber continuously until the end of the material feed. The mass of the melted crushed scrap is 16-18 t. Crushed material submerges into the molten metal and melts under conditions of the intensive stirring of the molten metal in the chamber. The melting of the solid metal in the molten metal ends in the vessel, wherein the metal is stirred by the jet inflowing from the chamber. Bulk feed and speed of the inflow of the jet of the molten metal into the vessel is 10-12 t/per minute and 2.5-3.0 m/per second accordingly.

Crushed chips are fed into the chamber and are melted down into the molten metal by the auger feeder.

The stirring regime upon the end of the solid material feed into the chamber, at the completion of melting of the material in the vessel and heating of the molten metal—intermittent (5/5 minutes).

The overflow of the molten metal from the melting furnace into the furnace-forehearth is made by the channel in the end wall of the chamber. The direction of the pumping of the molten metal is changed to the opposite by switching the order of the alternation of phases of the winding of the inductor. The molten metal under the influence of the running magnetic field stirs along the bottom to the end of the chamber, ascends the channel in the wall of the chamber and overflows by the chute into another reservoir. The duration of the overflow is 12-15 minutes.

The overflow is made of such amount of metal (16-18 t), which enables to proceed the melting of the crushed material in the remaining molten metal in the furnace.

The feed and melting of the crushed material is continued until the accumulation in the vessel of the furnace of 30 t of the molten metal, and afterwards 16-18 t of the metal from the furnace is overflown once again.

At change onto another assortment the molten metal remaining in the vessel after the overflow under the influence of the running magnetic field (h=150-200 mm—“marsh”) is discharged through the tap-hole of full discharge.

1. Method of induction stirring of the molten metal in the vessel of the reverberatory type furnace under the influence of the running magnetic field of the industrial (low) frequency (50:60 Hz), characterized in that the magnetic field acts on molten metal in horizontal direction along the plane—bottom of the chamber, located behind the wall of the furnace, molten metal under the influence of the magnetic field is pumped over from the chamber into the vessel along the bottom in the form of a flat drowned jet, the molten metal flows into the chamber to take place of the displaced mainly from the upper layer in the furnace, while stirring along the chamber the molten metal submerges to the bottom and changes direction to the inverse relative to the direction at the entrance into the chamber, the magnetic field acts on the molten metal at the (0.1:0.5) H height from the bottom of the vessel, wherein H—is the depth of the vessel, the speed of jet inflow into the vessel and the molten metal mass feed is regulated by means of changing the voltage on the winding of the inductor within the limits (0.5:1.1) Unom (rated voltage), the molten metal in the vessel is stirred in the intermittent regime, alternating periods of stirring and pauses.

2. Method according to claim 1, wherein the refinement of the molten metal in the vessel of the furnace is realized by the purge of the pumped metal with gas-flux mixture in the chamber and the closed volume of the chamber over the molten metal is filled with bubbling gas.

3. Method according to claim 1, wherein the scrap (crushed metal, metal chips) is fed to the surface of the molten metal stirring along the chamber and a quantity of solid metal sufficient for completion of the vessel of the furnace up to the nominal level (face value) is melted, the direction of the running magnetic field travel along the bottom of the chamber is reversed and the molten metal from the vessel is transferred under the influence of the magnetic field into the forehearth furnace (mixer) or another reservoir, leaving part of the molten metal in the vessel of the melting furnace, afterwards the magnetic field is reversed resuming the crushed scrap feed into the chamber and the scrap melting in the pumped molten metal is continued.

4. An apparatus for induction stirring of the molten metal in accordance with a method of claim 1, comprising in its structure the inductor of the running magnetic field (frequency 50:60 Hz) and a channel made of material proof against the molten metal influence, characterized in that the apparatus is made in a form of a module, which structure contains a frame with a unit placed therein, along the longitudinal axis of the unit there is a chamber, confined all length by end wall of the unit, the inductor is placed horizontally under the bottom of the chamber, the longitudinal axis of the chamber and the axle of the inductor are located in one vertical plane, the frame has weight capturing devices for lifting and travel, a flange and components for fastening of a module to the side wall of the furnace.

5. An apparatus according to claim 4, which contains unit-adaptor in the wall of a chamber, which has a window, dimensions and profile of a window from the outside of the wall being identical with a chamber window at the end of the unit, bottom of the window in the adaptor is realized edgewise the chamber with the inclination to the side of the bottom of the vessel of the furnace, window at the level of the bottom of the chamber expands to the side of the vessel of the furnace.

6. An apparatus according to claim 4, wherein in the end wall of the chamber is a channel, attached whereto is a tube for purge of the molten metal with gas-flux mixture.

7. An apparatus according to claim 4, wherein in the lid of the chamber is a hole and scrap, chips chamber feed system connects to the aperture.

8. An apparatus according to claim 4, wherein the end wall of the chamber contains a flat trench form slope channel, in the upper part of the channel attached thereto is a chute for overflow of the molten metal from the vessel of the furnace into another reservoir, the height of the trench—channel in the part adjacent to the bottom of the chamber—is within the limits of (1-2)d, where d—is the depth of the penetration of the variable (50:60 Hz) magnetic field into the molten metal.

9. An apparatus according to claim 4, wherein to the slope channel in the upper part thereof is attached pipe-siphon for the overflow of the molten metal from the vessel of the furnace into another reservoir.

10. An apparatus according to claim 7, wherein the end wall of the chamber contains a flat trench form slope channel, in the upper part of the channel attached thereto is a chute for overflow of the molten metal from the vessel of the furnace into another reservoir, the height of the trench—channel in the part adjacent to the bottom of the chamber—is within the limits of (1-2)d, where d—is the depth of the penetration of the variable (50:60 Hz) magnetic field into the molten metal.

11. An apparatus according to claim 8, wherein to the slope channel in the upper part thereof is attached pipe-siphon for the overflow of the molten metal from the vessel of the furnace into another reservoir.
